(19) United States
(12) Patent Application Publication
(10) Pub. No.: US 2026/0178020 A1
(43) Pub. Date: Jun. 25, 2026

(54) INFORMATION PROCESSING METHOD, INFORMATION PROCESSING APPARATUS, CONTROL METHOD FOR SEMICONDUCTOR MANUFACTURING SYSTEM, SEMICONDUCTOR MANUFACTURING SYSTEM, SEMICONDUCTOR MANUFACTURING METHOD, AND RECORDING MEDIUM

(71) Applicant: CANON KABUSHIKI KAISHA, Tokyo (JP)

(72) Inventor: KOJIRO HARA, Tokyo (JP)

(21) Appl. No.: 19/421,989

(22) Filed: Dec. 16, 2025

(30) Foreign Application Priority Data
Dec. 25, 2024 (JP) 2024-229245

(51) Int. Cl. G05B 19/418

(52) U.S. Cl. CPC G05B 19/41885; G05B 19/41865; G05B 2219/23316; G05B 2219/2602

(57) ABSTRACT

An information processing method in which processing to simulate a processing order of a plurality of lots in a manufacturing facility for manufacturing semiconductor is performed by a controller. The information processing method includes a first estimation step, a second estimation step, a first determination step, a second determination step, and an order determination step. The order determination step in which the controller determines to suspend start of a first processing for a first lot and to start the first processing for a second lot, when it has been determined in the first determination step that it is possible to start the first processing for the first lot, it has been determined in the second determination step that it is possible to start the first processing for the second lot, and a manufacture priority of the second lot is higher than a manufacture priority of the first lot.

### BACKGROUND

### Field of the Technology

The present disclosure relates to an information processing method, an information processing apparatus, a control method for a semiconductor manufacturing system, the semiconductor manufacturing system, a semiconductor manufacturing method, and a recording medium.

### Description of the Related Art

In recent years, in a manufacturing process for manufacturing semiconductor, for example, a process in which the order of flow of a plurality of lots to each processing apparatus in the manufacturing process is automatically controlled, each lot being one front opening unified pod (FOUP) holding a plurality of wafers, is proposed (see Japanese Patent Application Laid-Open No. H09-7912). Japanese Patent Application Laid-Open No. H09-7912 discloses reserving a certain processing apparatus for the next step such that a non-processing time of the lot processed in one processing apparatus is equal to or shorter than a maximum queue time.

However, in a case where a reservation is made to not exceed the maximum queue time for one lot as in Japanese Patent Application Laid-Open No. H09-7912, since the reservation is made in accordance with the availability status of the next processing apparatus, the manufacture priority of other lots is not considered at all even if there is a lot whose manufacture priority is high.

### SUMMARY

The present disclosure is directed to provide an information processing method, an information processing apparatus, a control method for a semiconductor manufacturing system, the semiconductor manufacturing system, a semiconductor manufacturing method, and a recording medium that are capable of realizing processing according to the manufacture priority.

According to a first aspect of the present disclosure, an information processing method in which processing to simulate a processing order of a plurality of lots in a manufacturing facility for manufacturing semiconductor is performed by a controller includes a first estimation step in which the controller estimates a first required time for a first lot to be released from a queue time limit, a second estimation step in which the controller estimates a second required time for a second lot to be released from the queue time limit, a first determination step in which the controller determines whether or not it is possible to start a first processing in the manufacturing facility for the first lot, on a basis of the first required time and a first maximum queue time in which it is allowed to leave the first lot unprocessed, a second determination step in which the controller determines whether or not it is possible to start the first processing in the manufacturing facility for the second lot, on a basis of the second required time and a second maximum queue time in which it is allowed to leave the second lot unprocessed, and an order determination step in which the controller determines to suspend start of the first processing for the first lot and to start the first processing for the second lot, in a case where it has been determined in the first determination step that it is possible to start the first processing for the first lot, it has been determined in the second determination step that it is possible to start the first processing for the second lot, and a manufacture priority of the second lot is higher than a manufacture priority of the first lot.

According to a second aspect of the present disclosure, an information processing apparatus includes a controller configured to perform processing to simulate a processing order of a plurality of lots in a manufacturing facility for manufacturing semiconductor. The controller is configured to execute a first estimation processing to estimate a first required time for a first lot to be released from a queue time limit, a second estimation processing to estimate a second required time for a second lot to be released from the queue time limit, a first determination processing to determine whether or not it is possible to start a first processing in the manufacturing facility for the first lot, on a basis of the first required time and a first maximum queue time in which it is allowed to leave the first lot unprocessed, a second determination processing to determine whether or not it is possible to start the first processing in the manufacturing facility for the second lot, on a basis of the second required time and a second maximum queue time in which it is allowed to leave the second lot unprocessed, and an order determination processing to determine to suspend start of the first processing for the first lot and to start the first processing for the second lot, in a case where it has been determined in the first determination processing that it is possible to start the first processing for the first lot, it has been determined in the second determination processing that it is possible to start the first processing for the second lot, and a manufacture priority of the second lot is higher than a manufacture priority of the first lot.

According to a third aspect of the present disclosure, a control method for a semiconductor manufacturing system including a manufacturing facility including a plurality of processing apparatuses configured to perform respective processing for manufacturing semiconductor, a management apparatus configured to manage the plurality of processing apparatuses, and an information processing apparatus including a controller configured to perform processing to simulate a processing order of a plurality of lots in the manufacturing facility and output information of the processing order to the management apparatus includes a first estimation step in which the controller estimates a first required time for a first lot to be released from a queue time limit, a second estimation step in which the controller estimates a second required time for a second lot to be released from the queue time limit, a first determination step in which the controller determines whether or not it is possible to start a first processing in the manufacturing facility for the first lot, on a basis of the first required time and a first maximum queue time in which it is allowed to leave the first lot unprocessed, a second determination step in which the controller determines whether or not it is possible to start the first processing in the manufacturing facility for the second lot, on a basis of the second required time and a second maximum queue time in which it is allowed to leave the second lot unprocessed, and an order determination step in which the controller determines to suspend start of the first processing for the first lot and to start the first processing for the second lot, in a case where it has been determined in the first determination step that it is possible to start the first processing for the first lot, it has been determined in the second determination step that it is possible to start the first processing for the second lot, and a manufacture priority of the second lot is higher than a manufacture priority of the first lot.

According to a fourth aspect of the present disclosure, a semiconductor manufacturing system includes a manufacturing facility including a plurality of processing apparatuses configured to perform respective processing for manufacturing semiconductor, a management apparatus configured to manage the plurality of processing apparatuses, and an information processing apparatus including a controller configured to perform processing to simulate a processing order of a plurality of lots in the manufacturing facility and output information of the processing order to the management apparatus. The controller is configured to execute a first estimation processing to estimate a first required time for a first lot to be released from a queue time limit, a second estimation processing to estimate a second required time for a second lot to be released from the queue time limit, a first determination processing to determine whether or not it is possible to start a first processing in the manufacturing facility for the first lot, on a basis of the first required time and a first maximum queue time in which it is allowed to leave the first lot unprocessed, a second determination processing to determine whether or not it is possible to start the first processing in the manufacturing facility for the second lot, on a basis of the second required time and a second maximum queue time in which it is allowed to leave the second lot unprocessed, and an order determination processing to determine to suspend start of the first processing for the first lot and to start the first processing for the second lot, in a case where it has been determined in the first determination processing that it is possible to start the first processing for the first lot, it has been determined in the second determination processing that it is possible to start the first processing for the second lot, and a manufacture priority of the second lot is higher than a manufacture priority of the first lot.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating a configuration of a semiconductor manufacturing system according to an embodiment.

FIG. 2 is a block diagram illustrating a flow of flow estimation processing in a flow simulator according to the embodiment.

FIG. 3 is an explanatory diagram illustrating a lot flow.

FIG. 4 is an explanatory diagram illustrating a lot flow in a case of exceeding a maximum queue time.

FIG. 5 is an explanatory diagram illustrating a setting status of the maximum queue time.

FIG. 6 is an explanatory diagram illustrating processing start determination of a first processing for a normal lot.

FIG. 7 is an explanatory diagram illustrating processing start determination of the first processing in a case where an express lot has arrived after the normal lot.

FIG. 8 is a sequence diagram illustrating a flow of control processing in the case where the express lot has arrived after the normal lot.

### DESCRIPTION OF THE EMBODIMENTS

The present embodiment will be described in accordance with drawings. To be noted, the embodiment below is an example, and can be modified in various ways.

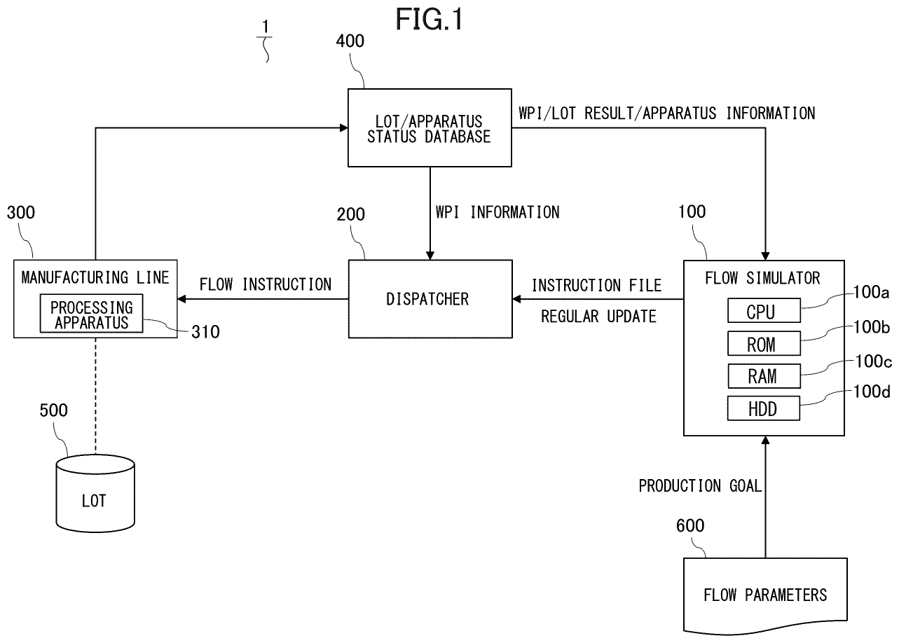

First, a schematic configuration of the entirety of a semiconductor manufacturing system that manufactures semiconductor will be described with reference to FIG. 1. FIG. 1 is a schematic diagram illustrating a configuration of the semiconductor manufacturing system according to the present embodiment.

As illustrated in FIG. 1, a semiconductor manufacturing system 1 according to the present embodiment roughly includes a flow simulator 100, a dispatcher 200, a manufacturing line 300, a lot/apparatus status database (hereinafter simply referred to as “database”) 400, and the like. This semiconductor manufacturing system 1 is a system that manufactures semiconductor by processing a lot 500 in which a plurality of (for example, 25 or less) semiconductor wafers are stored in a conveyance box such as FOUP, by processing apparatuses 310 that perform respective processing in the manufacturing line 300. Here, the flow is the flow of the wafers and the lot in the manufacturing line 300 for the semiconductor, and indicates the status of processing of the wafers and the lot.

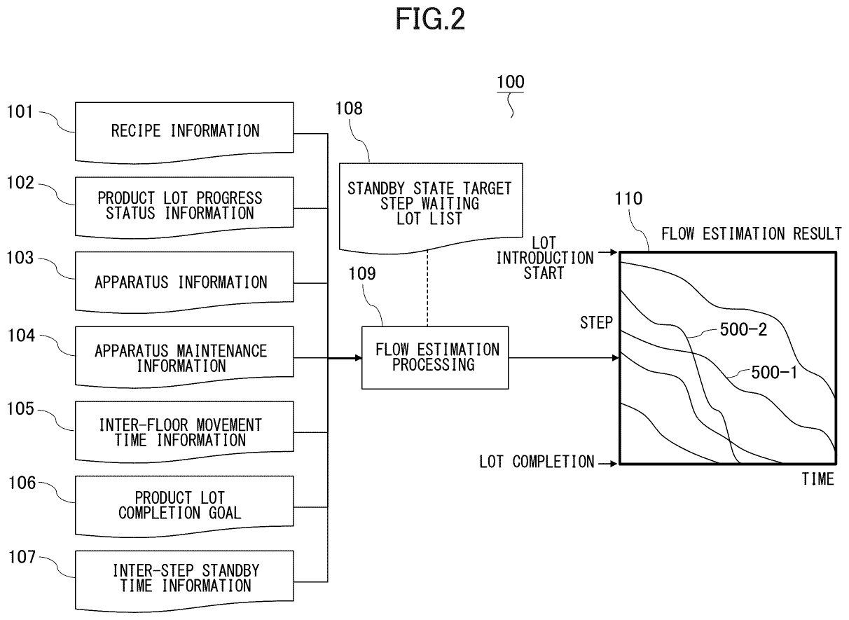

The flow simulator 100 described above is, for example, a computer, and includes a central processing unit (CPU) 100a serving as a controller, a read-only memory (ROM) 100b, a random access memory (RAM) 100c, and a hard disk drive (HDD) 100d that serve as recording portions or recording media. That is, the CPU 100a is configured to achieve the function as the flow simulator 100 by, for example, executing a program stored in the ROM 100b or the HDD 100d. The flow simulator 100 performs flow estimation processing 109 (see FIG. 2).

To be noted, the flow simulator 100 executes an information processing method for the CPU 100a to simulate the processing order of a plurality of lots 500 in the manufacturing line 300 for manufacturing a semiconductor wafer. In other words, the flow simulator 100 performs flow simulation. In addition, the flow simulator 100 is also an information processing apparatus that performs processing to simulate the processing order of the plurality of lots 500 in the manufacturing line 300 for manufacturing semiconductor wafers. In addition, although description will be given assuming that the program for executing the information processing described above is stored in the ROM 100b or the HDD 100d, the program may be stored in a recording medium that is externally connectable, such as an optical media or a flash memory.

The dispatcher 200 is, for example, a computer different from the flow simulator 100, and is communicably connected to the flow simulator 100, the database 400, and the plurality of processing apparatuses 310 of the manufacturing line 300. That is, the dispatcher 200 is configured as a management apparatus that transmits a flow instruction to the plurality of processing apparatuses 310, and thus manages the processing apparatuses 310 (manufacturing line 300). To be noted, the dispatcher 200 outputs a flow instruction based on the information of the flow estimation result to each processing apparatus 310 that performs each processing of the manufacturing line 300 (output step).

The manufacturing line 300 is a manufacturing facility for semiconductor wafers provided in a factory or the like. The manufacturing line 300 includes a plurality of processing apparatuses 310 that perform various processing such as oxidation of the surface, formation of a thin film, application of a resist, exposure, etching, peeling of the resist, ion injection, smoothing, formation of electrodes, assembly, and inspection, on wafers. For example, about 1 to 25 semiconductor wafers stored in a conveyance box constitute one lot 500. Further, in the manufacture, a plurality of lots 500 are put into the manufacturing line 300 to be processed. Putting a plurality of lots 500 into the manufacturing line 300 to be processed will be also referred to as “causing the lots to flow”. The plurality of processing apparatuses 310 in the manufacturing line 300 are arranged in series in a direction in which the lots 500 flow, but depending on the processing, only one processing apparatus 310 may be provided, or a plurality of (for example, three or more) processing apparatuses 310 may be arranged in parallel. That is, in the manufacturing line 300, a plurality of processing apparatuses 310 are often arranged in parallel particularly in the case where the processing apparatuses 310 perform processing that takes a long processing time.

The database 400 is, for example, a computer or a so-called file server different form the flow simulator 100 and the dispatcher 200. The database 400 stores information such as results of processing of the lots 500 by the processing apparatuses 310 of the manufacturing line 300, and transmits the information to the flow simulator 100 and the dispatcher 200. That is, the database 400 feeds back the information to the flow simulator 100 and the dispatcher 200. Specifically, the database 400 holds information such as a history indicating which lot 500 has been processed by which processing apparatus 310, and information of the status of each processing apparatus 310 (for example, information indicating that the processing apparatus 310 is in maintenance).

Next, the operation of the semiconductor manufacturing system 1 will be roughly described. First, the user (manager of the factory or the like) inputs flow parameters 600 that are information such as a production goal at information obtaining timings of predetermined intervals into the flow simulator 100. The predetermined interval can be, for example, once per day (24 hours). In addition, at the information obtaining timing, the flow simulator 100 loads work-in-progress (WIP) information of the plurality of lots 500, result information of the lots 500, apparatus information of the processing apparatuses 310, and the like stored in the database 400. The WIP information, the result information, and the apparatus information correspond to recipe information 101, product lot progress status information 102, apparatus information 103, apparatus maintenance information 104, inter-floor movement time information 105, inter-step maximum queue time information 107, and the like that are illustrated in FIG. 2 that will be described later. In addition, the flow parameters 600 correspond to a product lot completion goal 106 and the like. To be noted, the information obtaining timing is not limited to once per day, and may be set to any time interval such as once per several hours, once per hour, or once per several minutes, but may be set to an interval corresponding to the computational load on the flow simulator 100.

The flow simulator 100 simulates a flow estimation result 110 (see FIG. 2) that will be described in detail later from these various pieces of information that have been input. Then, the flow simulator 100 outputs the flow estimation result 110 to the dispatcher 200 as an instruction file (instruction information). To be noted, the instruction information can be regularly output at a timing when simulation is finished, such as once per day. Then, the information held by the dispatcher 200 can be regularly updated. To be noted, the calculation and output of the flow estimation result 110 to the dispatcher 200 can be performed at an interval corresponding to the information obtaining timing described above. That is, the flow estimation result 110 may be output to the dispatcher 200 each time the flow estimation result 110 is calculated from newly obtained information.

The dispatcher 200 issues a flow instruction to each processing apparatus 310 in the manufacturing line 300 at such timings that the flow matches the calculated flow estimation result 110 in accordance with the flow estimation result 110 input from the flow simulator 100 and the WIP information in the database 400. That is, the dispatcher 200 issues an instruction indicating which lot 500 is processed in which order. As a result of this, the plurality of lots 500 (that is, semiconductor wafers) are manufactured in a manner matching the flow estimation result 110 calculated by the flow simulator 100.

Next, the flow of the flow estimation processing in the flow simulator 100 will be described with reference to FIG. 2. FIG. 2 is a block diagram illustrating the flow of the flow estimation processing in the flow simulator 100 according to the present embodiment.

The flow simulator 100 described above obtains various information from the database 400 at the information obtaining timing, and also obtains the flow parameters 600 (see FIG. 1) via an unillustrated input terminal. That is, as illustrated in FIG. 2, the recipe information 101, the product lot progress status information 102, the apparatus information 103, the apparatus maintenance information 104, the inter-floor movement time information 105, the product lot completion goal 106, and the inter-step maximum queue time information 107 are input into the flow simulator 100 as an example of the flow parameters 600. The product lot completion goal 106 includes, for example, information of the production goal. To be noted, obtaining various information from the database 400 and obtaining the flow parameters 600 constitute an information obtaining step for obtaining at least information of the manufacture priority of a normal lot 500-1 and information of the manufacture priority of an express lot 500-2. Here, “express” and “normal” indicate the priority in processing. The express lot indicates that the lot should be processed with a higher priority than the normal lot and the processing thereof should be finished quickly. To be noted, the priority level is not limited to the two of express and normal, and a plurality of priority levels may be set.

Among these, the recipe information 101 is information indicating how the semiconductor wafers in the lot 500 are to be processed. The product lot progress status information 102 is information of the progress status of the processing of each lot 500 transmitted from each processing apparatus 310 of the manufacturing line 300. The apparatus information 103 is information of the status of each processing apparatus 310 transmitted from each processing apparatus 310 of the manufacturing line 300. The apparatus maintenance information 104 is information provided in the case where maintenance time is set in advance, and is, for example, information stored in the database 400. The inter-floor movement time information 105 is information of movement time in the case where the lot 500 is moved from a processing apparatus 310 to another processing apparatus 310 for the next processing, and is, for example, information stored in the database 400.

The product lot completion goal 106 is information for achieving a production goal including particularly the priority of the normal lot 500-1 serving as a first lot and the priority of the express lot 500-2 serving as a second lot. The inter-step maximum queue time information 107 includes information of the maximum queue time. The maximum queue time indicates a limit time in which the lot 500 (semiconductor wafers) may be left unprocessed after the processing performed by each processing apparatus 310. In other words, the maximum queue time can be also referred to as a time for restricting the non-processing time of the lot 500. Furthermore, the maximum queue time represents the longest permissible time from a specified process until another process is completed. And the maximum queue time also referred to as maximum allowable idle time. To be noted, setting a sufficient margin (for example, about 10%) for the maximum queue time such that the quality of the semiconductor wafers in the lot 500 does not deteriorate can be considered. That is, the maximum queue time may be set to a time shorter than the time after which the deterioration of the quality of the semiconductor wafers occurs.

Further, the flow simulator 100 performs flow estimation processing 109 for a virtual manufacturing line on the basis of the various information described above, and performs flow estimation in which virtual lots flow in accordance with virtual steps and virtual time. As a result of this, the user can understand in which step each lot 500 is at which time point, when each lot 500 is to be completed, and the like.

In addition, in the flow estimation, a lot 500 that is waiting to be put into a step serving as a target of queue time limit (queue time restriction) (hereinafter referred to as a “queue time limit target step”) in the virtual manufacturing line can be registered in a list 108 of lots waiting to be put into the queue time limit target step in the HDD 100d or the like. In this simulation, a determination processing performed in the case of introducing a lot waiting to be put into a processing apparatus will be described in detail later.

To be noted, the description below shows the details of the simulation virtually performed by the flow simulator 100. That is, the lots 500, the processing apparatuses 310, and the like are all virtual in the description, but will be just referred to as lots 500 and processing apparatuses 310 for the sake of convenience of description.

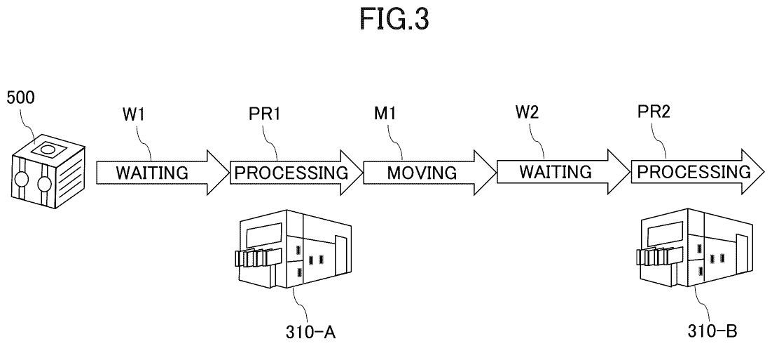

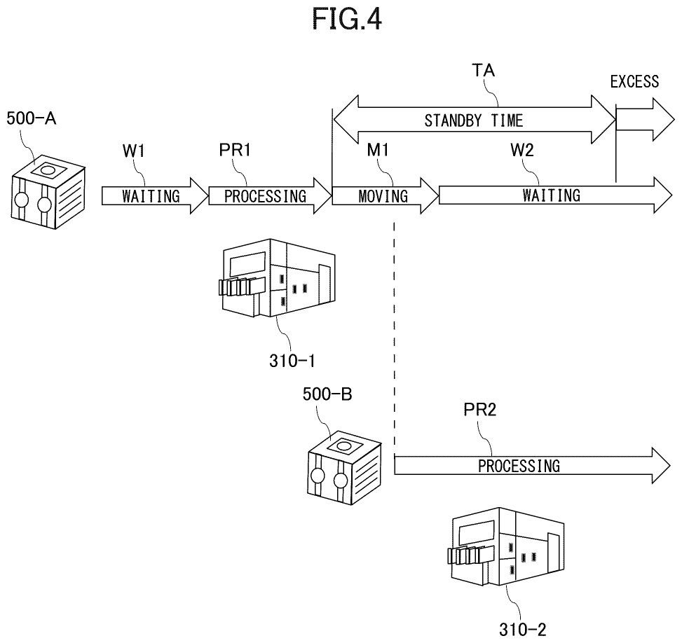

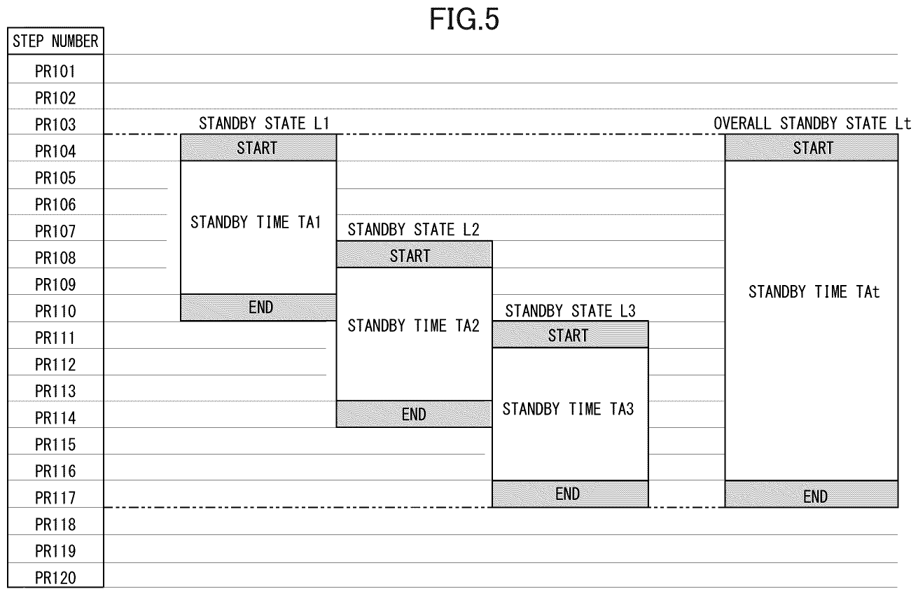

Next, the lot flow, and the maximum queue time occurring in the lot flow will be described with reference to FIGS. 3, 4, and 5. FIG. 3 is an explanatory diagram illustrating the lot flow. FIG. 4 is an explanatory diagram illustrating the lot flow in the case where the maximum queue time is exceeded. FIG. 5 is an explanatory diagram illustrating a setting state of the maximum queue time. To be noted, in the description below, the individual lots 500 and the individual processing apparatuses 310 are distinguished from each other by adding a hyphen and a suffix thereto in the case of distinguishing the individual lots 500 and the individual processing apparatuses 310 from each other, and the hyphen and the suffix are not used in the case where the distinction is not needed.

As illustrated in FIG. 3, the lot 500 waits until a processing apparatus 310-A which the lot 500 is to be put into becomes available (W1), and once the processing apparatus 310-A is available, the lot 500 is put into the processing apparatus 310-A, and the semiconductor wafers in the lot 500 are processed (PR1). After the processing by the processing apparatus 310-A is finished, the lot 500 is moved to a processing apparatus 310-B assigned with processing of the next manufacturing step (M1). In the case where the processing apparatus 310-B for the next manufacturing step is not available, the lot 500 waits until the processing apparatus 310-B becomes available (W2). Then, once the processing apparatus 310-B is available, the lot 500 is put into the processing apparatus 310-B, and the semiconductor wafers in the lot 500 are processed (PR2). The lot 500 becomes closer to completion by progressing each processing of the manufacturing steps in this manner.

To be noted, the processing apparatuses 310-A and 310-B do not perform processing that causes queue time limit on the lot 500 after the end of the processing. For example, there is a case where a plurality of lots 500 wait for the processing apparatus 310-A or 310-B to be available. Further, in the case where there is a lot with a higher priority that has, for example, a closer deadline, the lot with a higher priority is put into the processing apparatus 310-A or 310-B ahead of the other lots. That is, since the maximum queue time described later does not occur, the lot 500 is not kept waiting in consideration of the maximum queue time. Therefore, the introduction of the lot 500 into the processing apparatus 310 does not have to be determined in consideration of the maximum queue time, and the lot 500 can be simply put into the available processing apparatus 310 in accordance with the priority.

Next, a case where a maximum queue time is set will be described with reference to FIG. 4. Normally, the maximum queue time exists as a limit time from a time point when certain processing in the manufacturing process is finished to a time point when the next or later processing is started. The maximum queue time can be also referred to as a time before, for example, the quality deteriorates due to progress of oxidation or hardening of the surface of the semiconductor wafer. In the example of FIG. 4, a case where the maximum queue time determined as the maximum time in which the semiconductor wafers in the lot 500 can be left unprocessed after the processing by a processing apparatus 310-1 is set.

In the example illustrated in FIG. 4, a lot 500-A waits until the processing apparatus 310-1 becomes available (W1), but a maximum queue time TA is set after the end of the processing by the processing apparatus 310-1. In this condition, for example, the lot 500-A is put into the processing apparatus 310-1, the processing is finished, and the lot 500-A is moved toward a processing apparatus 310-2 (M1). It is assumed that, for example, a lot 500-B that is another lot is put into the processing apparatus 310-2 and the processing (PR2) is started during this. The lot 500-A has to wait until the processing apparatus 310-2 becomes available (W2), but if the processing of the lot 500-B (PR2) is not finished, there is a possibility that a maximum queue time TA is exceeded. Therefore, before putting the lot 500-A into the processing apparatus 310-1, a time between the end of the processing by the processing apparatus 310-1 and the start of the processing by the processing apparatus 310-2 is estimated. Then, in the case where the estimated time exceeds the maximum queue time TA, the introduction of the lot 500-A into the processing apparatus 310-1 needs to be prevented. To be noted, the time between the end of the processing by the processing apparatus 310-1 and the start of the processing by the processing apparatus 310-2 is estimated in consideration of the availability status of these apparatuses.

Here, calculation of the maximum queue time TA will be described with reference to FIG. 5. The vertical axis in FIG. 5 indicates the steps, and the strips in FIG. 5 each indicate for how many steps queue time limit L is set. The queue time limits can occur to partially overlap with each other in the case where a plurality of processes (also referred to as “steps” herein) are performed successively. That is, as illustrated in FIG>5, it is assumed that, for example, a certain lot 500 is put into processing that causes queue time limit L1 in a step number PR104. It is assumed that a maximum queue time TA1 is set for this queue time limit L1. It is indicated that the lot 500 needs to move on to the next processing before the end of the maximum queue time TA1 in a step number PR110.

Next, it is assumed that, for example, this lot 500 is put into processing that causes next queue time limit L2 in a step number PR108. It is assumed that a maximum queue time TA2 is set for this queue time limit L2. It is indicated that the lot 500 needs to move on to the next processing before the end of the maximum queue time TA2 in a step number PR114. Then, it is assumed that, for example, this lot 500 is put into processing that causes next queue time limit L3 in a step number PR111. It is assumed that a maximum queue time TA3 is set for this queue time limit L3. It is indicated that the lot 500 needs to move on to the next processing before the end of the maximum queue time TA3 in a step number PR117.

As described, in the case where the processing causing the queue time limit L1, the queue time limit L2, and the queue time limit L3 needs to be performed continuously as a series of processing, the lot 500 cannot be stopped during processing from the step number PR104 to the step number PR117 once the lot 500 is introduced. Therefore, in the flow estimation processing of the present embodiment, calculation is performed assuming that in the case where there is a series of processing in which queue time limits occur continuously as described above, overall queue time limit Lt and maximum queue time TAt occur as illustrated in FIG. 5.

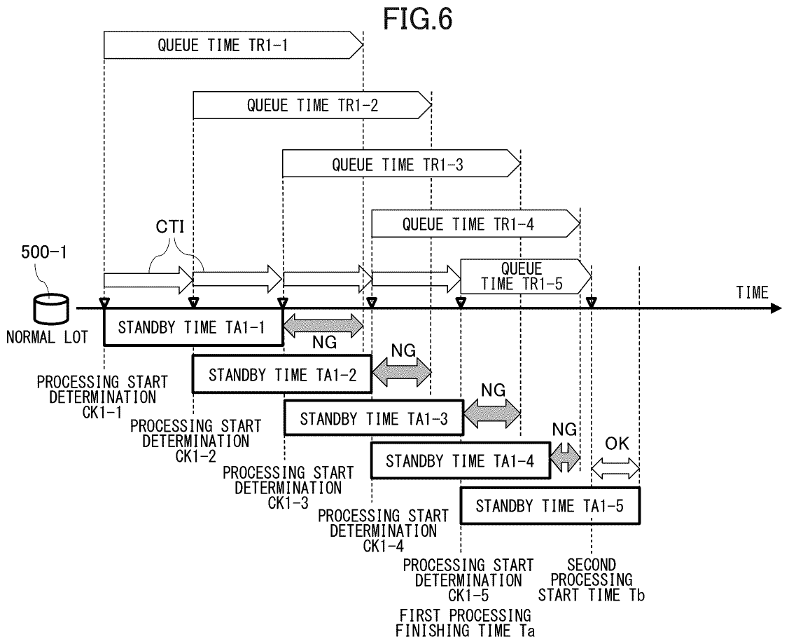

Next, processing start determination of a first processing to determine whether or not to put the normal lot 500-1 into the processing apparatus 310-1 will be described with reference to FIGS. 1, 4, and 6. FIG. 6 is an explanatory diagram illustrating processing start determination of the first processing for a normal lot.

To be noted, here, description will be given assuming that the processing apparatus 310-1 performs a first processing in the manufacturing process of the semiconductor wafer, and the processing apparatus 310-2 performs a second processing that is subsequent to the first processing in the manufacturing process of the semiconductor wafer. That is, description will be given assuming that the first processing is processing which is prior to the second processing and for which the maximum queue time TA is set. To be noted, although description will be given assuming that the second processing is processing subsequent to the first processing, the configuration is not limited to this, and one or more processes that cause queue time limit may be provided between the first processing and the second processing. That is, as in the example illustrated in FIG. 5, the end of the first processing may serve as a trigger for the start of the overall maximum queue time TAt in which a plurality of maximum queue times are set in an overlapping manner, and the second processing may be processing that should be performed before the elapse of the maximum queue time TAt.

The CPU 100a of the flow simulator 100 determines (checks) the availability status of each processing apparatus 310 of the manufacturing line 300 at a time interval (for example, 1-minute interval or the like) serving as a second set time (availability estimation step). Here, the 1-minute interval described as an example herein can be a value of the initial setting of the flow simulator 100. In addition, the 1-minute interval can be the minimum value of the time interval that can be set in the flow simulator 100. In the present embodiment, since the case of the minimum value will be described as an example, the time interval will be hereinafter referred to as a minimum time interval. However, the number of the flowing lots 500 and the number of the processing apparatuses 310 are enormous. Therefore, if the processing start determination of the first processing is performed at the minimum time interval (for example, 1-minute interval or the like), there is a possibility that the CPU 100a is overloaded. In addition, typically the processing of the lot 500 by the processing apparatus 310 takes several tens of minutes to several hours depending on the processing. Therefore, if the processing start determination of the first processing is performed at the minimum time interval (for example, 1-minute interval or the like), it is highly possible that there is little progress and the processing start determination is performed in vain. Therefore, in the present embodiment, a maximum queue time checking interval CTI (see FIG. 6) serving as a first set time that is a time interval for performing the processing start determination of the first processing is set to, for example, 30 minutes. The maximum queue time checking interval CTI can be individually set by the user, but may be collectively set for each processing apparatus to a value such as a half (50%) of the maximum queue time TA of the processing apparatus. In this case, if the maximum queue time TA that occurs after the first processing by the processing apparatus 310-1 is about 1 hour, the maximum queue time checking interval CTI is automatically set to about 30 minutes. For example, the setting of the maximum queue time checking interval CTI may be changed in accordance with the length of the maximum queue time TA. In the case where the maximum queue time TA is shorter than a predetermined value, the maximum queue time checking interval CTI may be set to 25% of the maximum queue time TA. In the case where the maximum queue time TA is equal to or longer than the predetermined value, the maximum queue time checking interval CTI may be set to 80% of the maximum queue time TA. The setting of the maximum queue time checking interval CTI can be changed in accordance with the length of the maximum queue time TA. In addition, after a step to determine the length of the maximum queue time TA is executed, a step to set the maximum queue time checking interval CTI can be executed in accordance with the result thereof.

To be noted, the minimum time interval (for example, 1-minute interval) and the maximum queue time checking interval CTI (for example, 30-minute interval) are each a time in a simulation result (flow estimation result), that is, a virtual time. Therefore, these time intervals are a result of the simulation by the flow simulator 100, and are not actual time intervals. For example, the flow simulator 100 performs flow estimation processing of several months of the manufacturing line 300 once per hour. However, since the dispatcher 200 controls the manufacturing line 300 by using the flow estimation result, the time in the flow estimation result eventually matches the actual time. Therefore, in the description below, description will be given as if the time in the flow estimation result is an actual time. To be noted, the frequency and period of the estimation by the flow simulator 100 are not limited to 1 hour and several months. For example, estimation of one day may be performed once per day.

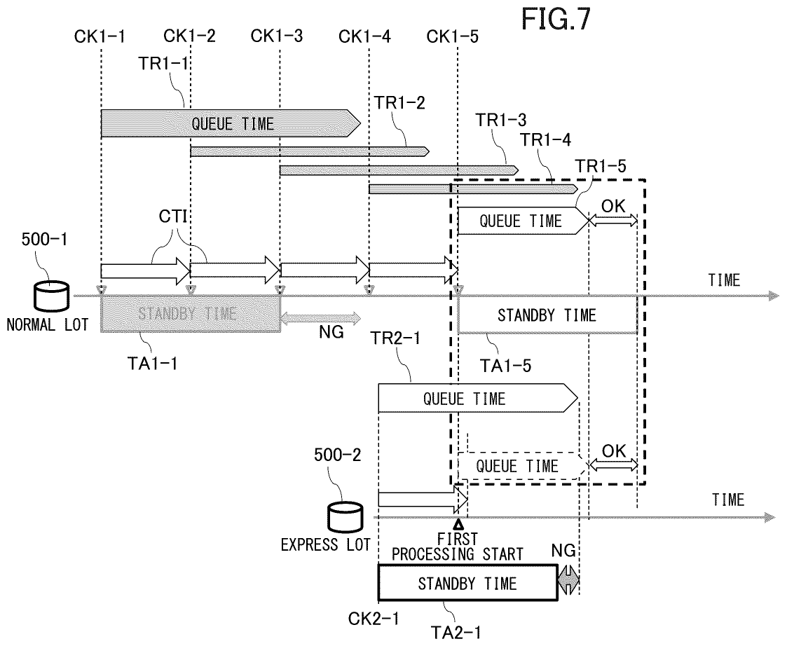

First, the details of a first processing start determination CK1-1 will be described. The CPU 100a estimates the availability status of the processing apparatus 310-2 at the minimum time interval as described above. Here, the CPU 100a estimates a required time TR1-1 serving as a first required time from a time point when the processing by the processing apparatus 310-1 is finished and a time point when the processing apparatus 310-2 becomes available in the case where the normal lot 500-1 is put into the processing apparatus 310-1 (first estimation step, first estimation processing). The required time TR1-1 is the sum of a time (M1) in which the normal lot 500-1 is moved from the processing apparatus 310-1 to the processing apparatus 310-2 and a time (W2) until the processing apparatus 310-2 becomes available (see FIG. 4). In other words, the required time TR-1 can be also referred to as a time from the end of the processing by the processing apparatus 310-1 to a time point when the queue time limit is released. In addition, in the case where there are a plurality of processing apparatuses 310-2 that perform the second processing serving as the next processing, the required time TR1-1 also changes depending on the number of the processing apparatuses 310-2, and also changes depending on the number of lots waiting for the start of the second processing by the processing apparatus 310-2. To be noted, similarly, required times TR1-2 to TR1-5 and TR2-1 (see FIG. 7) also change depending on the other lots 500 and the availability status (progress status) of the plurality of processing apparatuses 310-2.

Then, the CPU 100a obtains a maximum queue time TA1-1 (inter-step maximum queue time information 107) serving as a first maximum queue time occurring after the first processing on the normal lot 500-1 by the processing apparatus 310-1 is finished from the database 400 (see FIG. 1). To be noted, in the case where the maximum queue time is the overall maximum queue time of overlapping queue time limits described above, the CPU 100a may calculate the maximum queue time from the inter-step maximum queue time information 107, or calculated data may be stored in the database 400 in advance. In addition, in the present embodiment, the maximum queue times TA1-1 to TA1-5 (see FIG. 6) all occurring after the first processing and the maximum queue time TA2-1 (see FIG. 7) are each of the same length. Therefore, the CPU 100a obtains only one maximum queue time TA1-1 from the database 400.

Then, as the first processing start determination CK1-1, the CPU 100a determines whether or not it is possible to start the first processing on the normal lot 500-1 on the basis of the estimated required time TR1-1 and the maximum queue time TA1-1 (a first determination step, a first determination processing). That is, the CPU 100a compares the required time TR1-1 with the maximum queue time TA1-1, and in the case where the required time TR1-1 is longer than the maximum queue time TA1-1, the CPU 100a determines to suspend the start of the first processing on the normal lot 500-1 by the processing apparatus 310-1 (NG). Here, since the normal lot 500-1 waits to be put into the queue time limit target step, the CPU 100a records the normal lot 500-1 in the introduction waiting lot list 108 (see FIG. 2). To be noted, in the case where the required time TR1-1 is equal to or shorter than the maximum queue time TA1-1, the CPU 100a determines to start the first processing on the normal lot 500-1 by the processing apparatus 310-1 (OK).

As described above, in the case where it is determined to suspend the first processing on the normal lot 500-1 in the first processing start determination CK1-1, a second processing start determination CK1-2 is executed after the maximum queue time checking interval CTI (for example, 30 minutes). In this processing start determination CK1-2, similarly to the processing start determination CK1-1, the required time TR1-2 is estimated, and the required time TR1-2 is compared with maximum queue time TA1-2. Then, in the case where the required time TR1-2 is longer than the maximum queue time TA1-2 as illustrated in FIG. 6, the CPU 100a determines to suspend the start of the first processing on the normal lot 500-1 by the processing apparatus 310-1 (NG).

Further, similarly, in the case where it is determined to suspend the first processing on the normal lot 500-1 in the processing start determination CK1-2, third processing start determination CK1-3 is executed after the maximum queue time checking interval CTI (for example, 30 minutes). Also in this processing start determination CK1-3, in the case where the required time TR1-3 is longer than maximum queue time TA1-3 as illustrated in FIG. 6, the CPU 100a determines to suspend the start of the first processing on the normal lot 500-1 by the processing apparatus 310-1 (NG). Further, similarly, in the case where it is determined to suspend the first processing on the normal lot 500-1 in the processing start determination CK1-3, fourth processing start determination CK1-4 is executed after the maximum queue time checking interval CTI (for example, 30 minutes). Also in this processing start determination CK1-4, in the case where the required time TR1-4 is longer than maximum queue time TA1-4 as illustrated in FIG. 6, the CPU 100a determines to suspend the start of the first processing on the normal lot 500-1 by the processing apparatus 310-1 (NG).

Further, in the case where it is determined to suspend the first processing on the normal lot 500-1 in the processing start determination CK1-4, fifth processing start determination CK1-5 is executed after the maximum queue time checking interval CTI (for example, 30 minutes). In this processing start determination CK1-5, in the case where the required time TR1-5 is shorter than maximum queue time TA1-5 as illustrated in FIG. 6, the CPU 100a determines to start the first processing on the normal lot 500-1 by the processing apparatus 310-1 (OK). In other words, in the flow estimation result, introduction of the normal lot 500-1 into the processing apparatus 310-1 is reserved at this timing. As a result of this, as illustrated in FIG. 6, for the normal lot 500-1, the interval between an end time Ta when the first processing is finished and a start time Tb when the second processing can be started is shorter than the maximum queue time TA1-5. Therefore, a situation in which the normal lot 500-1 is left unprocessed after the end of the first processing and the maximum queue time TA1-5 is exceeded does not occur, and thus the deterioration of the quality can be suppressed. To be noted, in the case where it is determined to put the normal lot 500-1 into the processing apparatus 310-1, the record of the normal lot 500-1 is deleted from the introduction waiting lot list 108.

To be noted, the reservation of introduction of a lot refers to reserving introduction of a certain lot into a certain processing apparatus to be performed at a certain time, and guarantees that a different lot is not put into the processing apparatus at that time. To be noted, in the case of a processing apparatus capable of performing batch processing in which a plurality of lots can be processed, other lots can be additionally processed within the limitation thereof.

In addition, the queue time limit of the normal lot 500-1 and the queue time limit of the express lot 500-2 do not have to match completely. For example, a case where the queue time limits overlap with each other has been described with reference to FIG. 5, but if there is a queue time limit that completely overlaps with another queue time limit, such as a case where some queue time limits completely match, the queue time limit adds nothing to the maximum queue time, and therefore the corresponding lot may be introduced with a higher priority. For example, in the case where the maximum queue time is the same, if the queue time limit that occurs in the case where the lot passes through the processing apparatuses 310-A, 310-B, and 310-C in this order can be satisfied, the queue time limit that occurs in the case where the lot passes through the processing apparatuses 310-A and 310-B can be also satisfied.

Next, a case where the express lot 500-2 has arrived at the processing apparatus 310-1 while it is determined to suspend the start of the first processing (introduction) on the normal lot 500-1 by the processing apparatus 310-1 will be described with reference to FIG. 7. FIG. 7 is an explanatory diagram illustrating the processing start determination of the first processing in the case where the express lot has arrived after the normal lot.

As illustrated in FIG. 7, for the normal lot 500-1, the processing start determinations CK1-1 to CK1-4 have been performed, it has been determined that the required times TR1-1 to TR1-4 exceed the maximum queue times TA1-1 to TA1-4, and the introduction of the normal lot 500-1 into the processing apparatus 310-1 is suspended. To be noted, as described above, the normal lot 500-1 is recorded in the introduction waiting lot list 108 after the start of the processing start determination CK1-1.

For example, after the execution of the processing start determination CK1-4, when the express lot 500-2 arrives at the processing apparatus 310-1, the CPU 100a performs processing start determination CK2-1 for the express lot 500-2. That is, the CPU 100a estimates the required time TR2-1 serving as a second required time from the end of the first processing by the processing apparatus 310-1 to a time point when it becomes possible to start the second processing by the processing apparatus 310-2 (second estimation step, second estimation processing). Then, the required time TR2-1 is compared with maximum queue time TA2-1 serving as a second maximum queue time, and it is determined that the required time TR2-1 is longer than the maximum queue time TA2-1 (NG) (a second determination step, a second determination processing). Then, the introduction of the express lot 500-2 into the processing apparatus 310-1 (start of the first processing) is suspended. To be noted, the required time TR2-1 is also the sum of the time (M1) in which the normal lot 500-1 is moved from the processing apparatus 310-1 to the processing apparatus 310-2 and the time (W2) until the processing apparatus 310-2 becomes available (see FIG. 3). In other words, the required time TR2-1 can be also referred to as a time from the end of the processing by the processing apparatus 310-1 to a time point when the queue time limit is released.

To be noted, the maximum queue time TA2-1 of the express lot 500-2 is calculated to be equal to the maximum queue time TA1-1 of the normal lot 500-1 in the present embodiment. However, for example, in the case where the normal lot 500-1 includes twenty-five semiconductor wafers and the express lot 500-2 includes only one semiconductor wafer, the actual maximum queue times can be different, and therefore the maximum queue time may be changed in accordance with the number of the semiconductor wafers. In addition, the CPU 100a also records the express lot 500-2 in the introduction waiting lot list 108 because introduction thereof into the processing apparatus 310-1 is suspended.

Next, in response to the elapse of the maximum queue time checking interval CTI (for example, 30 minutes) since the processing start determination CK1-4, the CPU 100a performs processing start determination CK1-5 for the normal lot 500-1. In the processing start determination CK1-5, the required time TR1-5 is shorter than maximum queue time TA1-5, and the CPU 100a determines that the first processing by the processing apparatus 310-1 can be started on the normal lot 500-1 (normal lot 500-1 can be introduced).

Here, the CPU 100a refers to the introduction waiting lot list 108, and determines that the express lot 500-2 is recorded in the introduction waiting lot list 108. Then, the CPU 100a refers to the priority of the normal lot 500-1 and the priority of the express lot 500-2 in, for example, information such as the product lot completion goal 106, and determines that the express lot 500-2 has a higher priority. Therefore, the CPU 100a determines to start the first processing of the express lot 500-2 by the processing apparatus 310-1 (introduce the express lot 500-2 into the processing apparatus 310-1) instead of starting the first processing of the normal lot 500-1 by the processing apparatus 310-1 (introducing the normal lot 500-1 into the processing apparatus 310-1) (an order determination step, an order determination processing).

As a result of this, it is determined to suspend the start of the first processing by the processing apparatus 310-1 on the normal lot 500-1, and it is determined to start the first processing by the processing apparatus 310-1 on the express lot 500-2 ahead of the normal lot 500-1. Therefore, as shown in the flow estimation result in FIG. 2, the express lot 500-2 having a higher priority than the normal lot 500-1 can be prioritized, and thus the first processing by the processing apparatus 310-1 is started in a manner in which the processing order is intentionally switched. Therefore, the processing of the express lot 500-2 in the manufacturing line 300 is progressed with a higher priority while suppressing excess from the maximum queue time TA2-1.

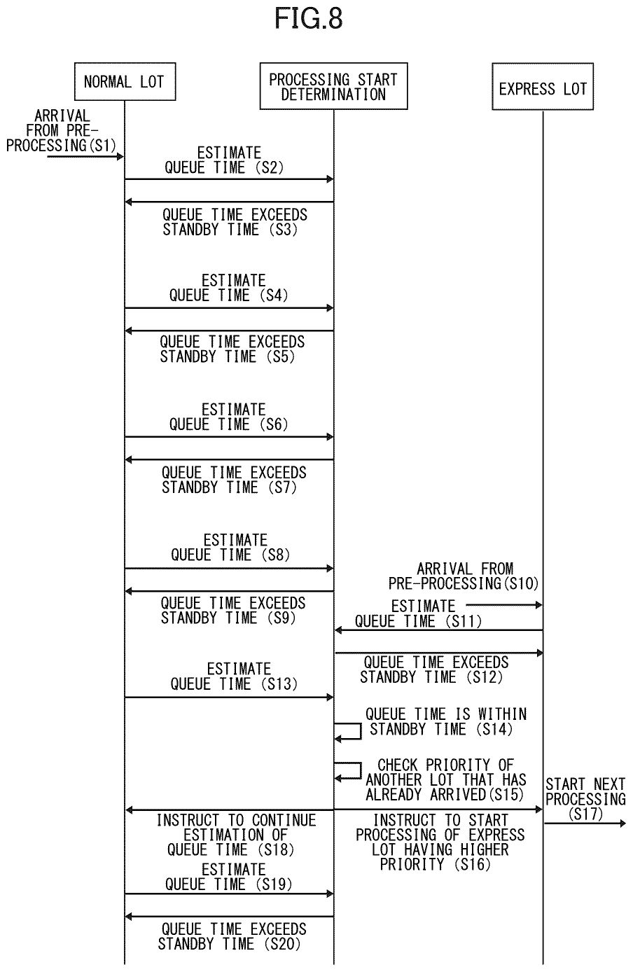

Next, the flow of the control processing in the case where the express lot has arrived after the normal lot as described above will be described with reference to FIG. 8. FIG. 8 is a sequence diagram illustrating the flow of the control processing in the case where the express lot has arrived after the normal lot.

As illustrated in FIG. 8, the pre-processing of the normal lot 500-1 is finished, and the normal lot 500-1 arrives at the processing apparatus 310-1 (S1). Then, the CPU 100a calculates and estimates the required time TR1-1 (S2), and determines that the required time TR1-1 exceeds the maximum queue time TA1-1 (S3). As a result of this, the start of the first processing of the normal lot 500-1 by the processing apparatus 310-1 is suspended, and the normal lot 500-1 is recorded in the introduction waiting lot list 108.

Next, the CPU 100a performs the processing start determination CK1-2 on the normal lot 500-1 in response to the elapse of the maximum queue time checking interval CTI since the processing start determination CK1-1. Then, the CPU 100a calculates and estimates the required time TR1-2 (S4), and when it is determined that the required time TR1-2 exceeds the maximum queue time TA1-2 (S5), the start of the first processing of the normal lot 500-1 by the processing apparatus 310-1 is suspended.

Similarly, the CPU 100a performs the processing start determination CK1-3 on the normal lot 500-1 in response to the elapse of the maximum queue time checking interval CTI since the processing start determination CK1-2. Then, the CPU 100a calculates and estimates the required time TR1-3 (S6), and when it is determined that the required time TR1-3 exceeds the maximum queue time TA1-3 (S7), the start of the first processing of the normal lot 500-1 by the processing apparatus 310-1 is suspended.

Further, similarly, the CPU 100a performs the processing start determination CK1-4 on the normal lot 500-1 in response to the elapse of the maximum queue time checking interval CTI since the processing start determination CK1-3. Then, the CPU 100a calculates and estimates the required time TR1-4 (S8), and when it is determined that the required time TR1-4 exceeds the maximum queue time TA1-4 (S9), the start of the first processing of the normal lot 500-1 by the processing apparatus 310-1 is suspended.

Here, the pre-processing of the express lot 500-2 is finished and the express lot 500-2 arrives at the processing apparatus 310-1 (S10). In this case, the CPU 100a calculates and estimates the required time TR2-1 (S11), and determines that the required time TR2-1 exceeds the maximum queue time TA2-1 (S12). As a result of this, the start of the first processing of the express lot 500-2 by the processing apparatus 310-1 is suspended, and the express lot 500-2 is recorded in the introduction waiting lot list 108.

Then, the CPU 100a performs the processing start determination CK1-5 on the normal lot 500-1 in response to the elapse of the maximum queue time checking interval CTI since the processing start determination CK1-4. Then, the CPU 100a calculates and estimates the required time TR1-5 (S13), and determines that the required time TR1-5 is within the maximum queue time TA1-5 (S14). Here, the CPU 100a checks the priority of another lot that has arrived, that is, the express lot 500-2 by referring to the introduction waiting lot list 108 (S15). Then, the CPU 100a determines to start the first processing of the express lot 500-2 having a higher priority, and instructs to put the express lot 500-2 into the processing apparatus 310-1 (S16). Therefore, the first processing by the processing apparatus 310-1 serving as the next processing is performed on the express lot 500-2 (S17). To be noted, in the case where the normal lot and the express lot differ in the maximum queue time, a step to estimate the required time of the express lot 500-2 and a step to determine whether or not the required time is within the maximum queue time may be provided after step S15 and before step S16. In the case where the required time is not within the maximum queue time, the normal lot may be processed before the express lot.

In contrast, for the normal lot 500-1, the CPU 100a instructs to suspend the start of the first processing by the processing apparatus 310-1, that is, to continue to perform the processing start determination (estimation of the required time) for the next time and later (S18). Therefore, in response to the elapse of the maximum queue time checking interval CTI since the processing start determination CK1-5, the next processing start determination is performed on the normal lot 500-1. Then, the CPU 100a calculates and estimates the next required time (S19), determines that the required time exceeds the maximum queue time (S20), and the start of the first processing of the normal lot 500-1 by the processing apparatus 310-1 is suspended.

As a result of the processing described above, it is determined to suspend the start of the first processing of the normal lot 500-1 by the processing apparatus 310-1, and it is determined to start the first processing of the express lot 500-2 by the processing apparatus 310-1 ahead of the normal lot 500-1. Therefore, the express lot 500-2 having a higher priority than the normal lot 500-1 can be prioritized, that is, the first processing by the processing apparatus 310-1 is started in a manner in which the processing order is intentionally switched. Therefore, the processing of the express lot 500-2 in the manufacturing line 300 is progressed with a higher priority while suppressing excess from the maximum queue time TA2-1. Here, as a reference example, a configuration in which reservation is made for one lot to not exceed the maximum queue time is considered. In this reference example, since the reservation is made in accordance with the availability status of the next processing apparatus, the manufacture priority of other lots is not considered at all even if there is a lot whose manufacture priority is high. In this case, there is a problem that even if there is a lot with a high manufacture priority, there is a possibility that the lot is not likely to be prioritized. In contrast, according to the present embodiment, the processing of a second lot having a higher priority than a first lot can be prioritized, that is, processing according to priority can be realized.

According to the present disclosure, the processing of the second lot (express lot 500-2) having a higher priority than the first lot (normal lot 500-1) can be prioritized.

To be noted, in the present embodiment described above, a case where when estimating the required time, time from the end of the first processing by the processing apparatus 310-1 to the start of the second processing by the processing apparatus 310-2 is calculated has been described. However, the configuration is not limited to this, and for example, the processing time of the first processing may be included in the calculated required time. In this case, the processing time of the first processing is also included in the calculated maximum queue time. In addition, the processing time of the second processing may be included in the calculated required time. In this case, the processing time of the second processing is also included in the calculated maximum queue time.

In addition, in the embodiment described above, a case where it is determined to start the first processing in the case where the required time is shorter than the maximum queue time has been described. However, the configuration is not limited to this, and a configuration in which only a case where the required time is longer than the maximum queue time is determined, that is, only whether to suspend the start of the first processing is determined may be employed. Conversely, although a case where it is determined to suspend the start of the first processing in the case where the required time is longer than the maximum queue time has been described, the configuration is not limited to this, and a configuration in which only a case where the required time is shorter than the maximum queue time is determined, that is, only whether to start the first processing is determined may be employed. That is, the CPU 100a of the flow simulator 100 does not necessarily need to make determination on both cases, and a configuration in which one is determined by using the determination result of the other may be employed.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable recording medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-229245, filed Dec. 25, 2024 which is hereby incorporated by reference herein in its entirety.

What is claimed is:

1. An information processing method in which processing to simulate a processing order of a plurality of lots in a manufacturing facility for manufacturing semiconductor is performed by a controller, the information processing method comprising:
a first estimation step in which the controller estimates a first required time for a first lot to be released from a queue time limit;
a second estimation step in which the controller estimates a second required time for a second lot to be released from the queue time limit;
a first determination step in which the controller determines whether or not it is possible to start a first processing in the manufacturing facility for the first lot, on a basis of the first required time and a first maximum queue time in which it is allowed to leave the first lot unprocessed;
a second determination step in which the controller determines whether or not it is possible to start the first processing in the manufacturing facility for the second lot, on a basis of the second required time and a second maximum queue time in which it is allowed to leave the second lot unprocessed; and
an order determination step in which the controller determines to suspend start of the first processing for the first lot and to start the first processing for the second lot, in a case where it has been determined in the first determination step that it is possible to start the first processing for the first lot, it has been determined in the second determination step that it is possible to start the first processing for the second lot, and a manufacture priority of the second lot is higher than a manufacture priority of the first lot.

2. The information processing method according to claim 1,
wherein in the first estimation step, the controller estimates, as the first required time, a time between a time point when the first processing for the first lot is finished and a time point when it becomes possible to start a second processing for the first lot, the second processing being processing after the first processing,
wherein in the second estimation step, the controller estimates, as the second required time, a time between a time point when the first processing for the second lot is started and a time point when it becomes possible to start the second processing for the second lot,
wherein in the first determination step, the controller determines to suspend the start of the first processing for the first lot in a case where the first required time is longer than the first maximum queue time, and
wherein in the second determination step, the controller determines to suspend the start of the first processing for the second lot in a case where the second required time is longer than the second maximum queue time.

3. The information processing method according to claim 2,
wherein in the first determination step, the controller determines to start the first processing for the first lot in a case where the first required time is shorter than the first maximum queue time, and
wherein in the second determination step, the controller determines to start the first processing for the second lot in a case where the second required time is shorter than the second maximum queue time.

4. The information processing method according to claim 2, wherein in the order determination step, the controller re-executes the first determination step in response to elapse of a first set time in a case where the controller has determined to suspend the start of the first processing for the first lot.

5. The information processing method according to claim 2, wherein in the first determination step, the controller re-executes the first determination step in response to elapse of a first set time in a case where the controller has determined to suspend the start of the first processing for the first lot.

6. The information processing method according to claim 5, wherein in the order determination step, the controller determines to start the first processing for the first lot instead of the second lot in a case where the controller has determined that it is possible to start the first processing for the first lot in the first determination step after the controller has determined to suspend the start of the first processing for the second lot in the second determination step.

7. The information processing method according to claim 6, wherein the controller re-executes the first determination step after the controller has determined to start the first processing for the first lot instead of the second lot.

8. The information processing method according to claim 5, further comprising:
an availability estimation step in which the controller estimates, each time a second set time elapses, an availability status of each processing apparatus that performs each processing of the manufacturing facility,
wherein the first set time is set to be longer than the second set time.

9. The information processing method according to claim 8,
wherein in the first estimation step, the controller estimates the first required time on a basis of the availability status of each processing apparatus estimated in the availability estimation step, and
wherein in the second estimation step, the controller estimates the second required time on the basis of the availability status of each processing apparatus estimated in the availability estimation step.

10. The information processing method according to claim 1, further comprising an information obtaining step in which the controller obtains at least information of the manufacture priority of the first lot and information of the manufacture priority of the second lot.

11. The information processing method according to claim 10, wherein in the information obtaining step, the controller obtains information of a status of each processing apparatus that performs each processing in the manufacturing facility.

12. The information processing method according to claim 10, wherein in the information obtaining step, the controller obtains information of a progress status of each lot in the manufacturing facility.

13. The information processing method according to claim 10, wherein in the information obtaining step, the controller obtains information of each maximum queue time between each processing in the manufacturing facility.

14. The information processing method according to claim 10, wherein in the information obtaining step, the controller obtains information of movement time of lots between each processing apparatus that performs each processing in the manufacturing facility.

15. The information processing method according to claim 1, further comprising an output step in which the controller outputs information indicating a result of the order determination step to a management apparatus that manages each processing apparatus that performs each processing in the manufacturing facility.

16. An information processing apparatus comprising:
a controller configured to perform processing to simulate a processing order of a plurality of lots in a manufacturing facility for manufacturing semiconductor,
wherein the controller is configured to execute:
a first estimation processing to estimate a first required time for a first lot to be released from a queue time limit;
a second estimation processing to estimate a second required time for a second lot to be released from the queue time limit;
a first determination processing to determine whether or not it is possible to start a first processing in the manufacturing facility for the first lot, on a basis of the first required time and a first maximum queue time in which it is allowed to leave the first lot unprocessed;
a second determination processing to determine whether or not it is possible to start the first processing in the manufacturing facility for the second lot, on a basis of the second required time and a second maximum queue time in which it is allowed to leave the second lot unprocessed; and
an order determination processing to determine to suspend start of the first processing for the first lot and to start the first processing for the second lot, in a case where it has been determined in the first determination processing that it is possible to start the first processing for the first lot, it has been determined in the second determination processing that it is possible to start the first processing for the second lot, and a manufacture priority of the second lot is higher than a manufacture priority of the first lot.

17. A control method for a semiconductor manufacturing system including a manufacturing facility including a plurality of processing apparatuses configured to perform respective processing for manufacturing semiconductor, a management apparatus configured to manage the plurality of processing apparatuses, and an information processing apparatus including a controller configured to perform processing to simulate a processing order of a plurality of lots in the manufacturing facility and output information of the processing order to the management apparatus, the control method comprising:
a first estimation step in which the controller estimates a first required time for a first lot to be released from a queue time limit;
a second estimation step in which the controller estimates a second required time for a second lot to be released from the queue time limit;
a first determination step in which the controller determines whether or not it is possible to start a first processing in the manufacturing facility for the first lot, on a basis of the first required time and a first maximum queue time in which it is allowed to leave the first lot unprocessed;
a second determination step in which the controller determines whether or not it is possible to start the first processing in the manufacturing facility for the second lot, on a basis of the second required time and a second maximum queue time in which it is allowed to leave the second lot unprocessed; and
an order determination step in which the controller determines to suspend start of the first processing for the first lot and to start the first processing for the second lot, in a case where it has been determined in the first determination step that it is possible to start the first processing for the first lot, it has been determined in the second determination step that it is possible to start the first processing for the second lot, and a manufacture priority of the second lot is higher than a manufacture priority of the first lot.

18. A semiconductor manufacturing system comprising:
a manufacturing facility including a plurality of processing apparatuses configured to perform respective processing for manufacturing semiconductor;
a management apparatus configured to manage the plurality of processing apparatuses; and
an information processing apparatus including a controller configured to perform processing to simulate a processing order of a plurality of lots in the manufacturing facility and output information of the processing order to the management apparatus,
wherein the controller is configured to execute:
a first estimation processing to estimate a first required time for a first lot to be released from a queue time limit;
a second estimation processing to estimate a second required time for a second lot to be released from the queue time limit;
a first determination processing to determine whether or not it is possible to start a first processing in the manufacturing facility for the first lot, on a basis of the first required time and a first maximum queue time in which it is allowed to leave the first lot unprocessed;
a second determination processing to determine whether or not it is possible to start the first processing in the manufacturing facility for the second lot, on a basis of the second required time and a second maximum queue time in which it is allowed to leave the second lot unprocessed; and
an order determination processing to determine to suspend start of the first processing for the first lot and to start the first processing for the second lot, in a case where it has been determined in the first determination processing that it is possible to start the first processing for the first lot, it has been determined in the second determination processing that it is possible to start the first processing for the second lot, and a manufacture priority of the second lot is higher than a manufacture priority of the first lot.

19. A semiconductor manufacturing method comprising manufacturing semiconductor by using the semiconductor manufacturing system according to claim 18.

20. A non-transitory computer-readable recording medium storing a program for causing a computer to execute the information processing method according to claim 1.
